(19) United States
(12) Patent Application Publication
(10) Pub. No.: US 2002/0091679 A1
(43) Pub. Date: Jul. 11, 2002

(54) System for searching collections of linked objects

(76) Inventor: James E. Wright, Jamaica Plain, MA (US)

Correspondence Address: Elizabeth E. Nugent, Choate, Hall & Stewart, Exchange Place, 53 State Street, Boston, MA, 02109, US

(21) Appl. No.: 09/757,849

(22) Filed: Jan. 9, 2001

(51) Int. Cl. G06F 17/30

(52) U.S. Cl. 707/3

(57) ABSTRACT

A method of searching and displaying information from searches that allows users to rapidly determine the most useful search objects. The method includes determining target objects linked to by objects in a search set, and displaying information about the links between objects in the search set and/or from objects in the search set to objects outside of the search set. Displays may include 2D or 3D displays or graphs of object representations, which may be formatted in independently displayable layers. Display attributes such as color, size, shape, and position may be used to convey metadata about displayed objects and/or links.

### FIELD OF THE INVENTION

The present invention is related to techniques of searching collections of linked objects, and in particular to techniques for displaying metadata regarding link structure and object properties to enable more rapid searching.

### BACKGROUND OF THE INVENTION

Many companies, such as Lycos, Yahoo, Alta Vista, and Google, offer search engines for searching for information on the World Wide Web (hereinafter, “WWW” or “web”). More specialized search technologies are also available for specific research areas such as law (e.g., Westlaw, Lexis), medicine (e.g., Medline), and science (e.g., INSPEC, SciSearch). Generally, such search engines allow a user to perform “keyword” searching, possibly allowing users to specify that keywords should only appear in certain fields (e.g., author, journal).

Much research has gone into how to optimize both generalized and subject specific searches to more accurately find the results the end-user of the search application is looking for. However, the differences between most commercial search technologies lie in the search methodologies employed, i e., the search algorithms themselves. When results are finally presented to the user, they are most often presented in a simple list from which the user must pick the items that are relevant, either by viewing each document directly or by viewing metadata displayed in the search result (such as number of times the search words appear).

Advanced search algorithms may provide some assistance to the user in locating relevant data from a large data set, some portion of which is likely irrelevant to the search at hand, and in ranking the relevance of the returned results. However, in many cases, the search algorithm simply cannot “know” what the user is really looking for.

Compared to generalized search engines or search engines used for the broad category of web content, specialized search systems (e.g., for legal research) are able to take more sophisticated and specific inputs from the user, and thus to generate results more closely tailored to the user's requests. However, even for these systems, the results generated are often too voluminous for the user to process easily, and a very high percentage of irrelevant data is frequently presented, which the user must then manually sift through to find the data he seeks.

A need remains for a computer-based method of searching through large quantities of data that allows the user to effectively and quickly pick out only the items of interest to the task at hand.

### SUMMARY OF THE INVENTION

An object of the present invention is to supply this need by providing a method of graphical display of information about search result sets. In particular, the present invention provides a method of displaying link information for collections of objects having “hyperlinks” or other references from one to another. The invention provides valuable information to the user about the interrelatedness of the objects, and further allows the user to rapidly and efficiently selectively display metadata relating to the objects and to the links.

In one aspect, the invention comprises methods of searching collections of linked objects and displaying results of the search. The methods comprise acquiring a search group of heterogeneously typed objects, where at least one of the search group members comprises a link to another object. (By “heterogeneously typed,” it is meant that the search objects are of structurally different types, e.g., legal opinions and law review articles. The type of metadata associated with an object will typically depend on its type). The targets of links from at least a portion of the search group are then determined, including determining whether the link targets are inside the search group (this determination may be performed recursively, e.g., using 1-10 levels of recursion). A representation of at least one searched object is then displayed, where a display attribute of the representation is determined by the set of link targets.

In another aspect, the invention comprises methods of searching collections of linked objects and displaying the results of the search. The methods include acquiring a search group of objects, and determining the targets of links from at least a portion of the objects in the search group (this determination may be performed recursively, e.g., using 1-10 levels of recursion), including determining whether the link targets are inside the search group. A representation of at least one of the searched objects is then displayed, where at least one display attribute of the representation is determined by the determined link targets. Displayed representations are arranged into a plurality of display layers, which may be independently hidden or displayed.

For methods according to each of the above aspects, objects may be displayed on a graph, and links between objects may be displayed by connectors. Link display properties may be determined by factors such as the linking object type, the target object type, and the link type. Display attributes may be determined by object metadata.

Displayed representations may be divided into one or more display layers that can be independently hidden or displayed. Search objects may be of a variety of types, including legal opinions, treatises, statutes, briefs, and law review articles; scientific or medical writings; or patents and patent applications. Search objects may be annotated to include user notations on the search objects. These annotations may be saved and may appear in subsequent searches.

In yet another aspect, the invention comprises a method of searching a collection of objects and displaying results. The method includes annotating one or more objects of the search, and selectively displaying the annotations. The annotations may persist, so that they appear when the annotated object is found in a subsequent search. The display of the search objects may be on a graph. If search objects are linked and the links are displayed as connectors, the connectors may also be annotated.

“Search group,” as that term is used herein, is intended to refer to a subset of a collection of objects, the subset determined by a search algorithm such as keyword, attribute, or natural language searching.

“Link,” as that term is used herein, is intended to refer to a reference by one object to another object. Examples of links include hyperlinks (e.g., between HTML or XML objects), citations (e.g., citations to legal opinions or statutes in legal documents, citations in scientific papers to other publications, or references to prior art or related applications in patents), and master/detail record links in a relational database. Links may be either one-way or two-way.

“Link target,” as that term is used herein, is intended to refer to an object that is referred to by another object.

“Display attribute,” as that term is used herein, is intended to refer to a display property (including but not limited to color, shape, size, position, highlighting, graphical flags, and labeling text) that may be used to convey information about an object.

“Object metadata,” as that term is used herein, includes information about a particular object, which may include but is not limited to the number and targets of links from the object, the number and sources of links to the object, the type of the object, date and source information, context of search words for the object, and summary information about the object such as abstracts and topical information.

“Graph,” as that term is used herein, is intended to refer to a two-dimensional or three-dimensional visual representation of linked objects, where a link is displayed as a connector.

“Connector,” as that term is used herein, is intended to refer to a visual representation of a link between objects that indicates the source and/or the target of the link. Connectors may, for example, be shown as lines or arrows.

“Tip,” as that term is used herein, is intended to refer to text or other information about an object that is selectively displayed on a computer system only when a display pointer is placed over or near the object or when the object is otherwise selected.

### BRIEF DESCRIPTION OF THE DRAWING

The patent or application file contains at least one drawing executed in color. Copies of this patent or patent application publication with color drawings will be provided by the Office upon request and payment of the necessary fee.

The invention is described with reference to the several figures of the drawing, in which,

FIG. 1 is an example of typical prior art search displays;

FIG. 2 is an example of a search result display according to the invention;

FIG. 3 shows a layer properties dialog;

FIG. 4 shows a dialog for defining which objects appear in each layer;

FIG. 5 shows a link properties wizard;

FIG. 6 shows a sorting wizard;

FIG. 7 shows a group creation dialog;

FIG. 8 shows a group definition wizard; and

FIG. 9 shows a group display wizard;

### DETAILED DESCRIPTION

The present invention encompasses the realization that links among search objects may convey as much or more information about the relevance of the objects as titles or other typical displayed data. In addition, in certain contexts such as legal searching, the existence of a link (citation) may have independent significance, in addition to providing information relating to the relevance of the linking and target objects.

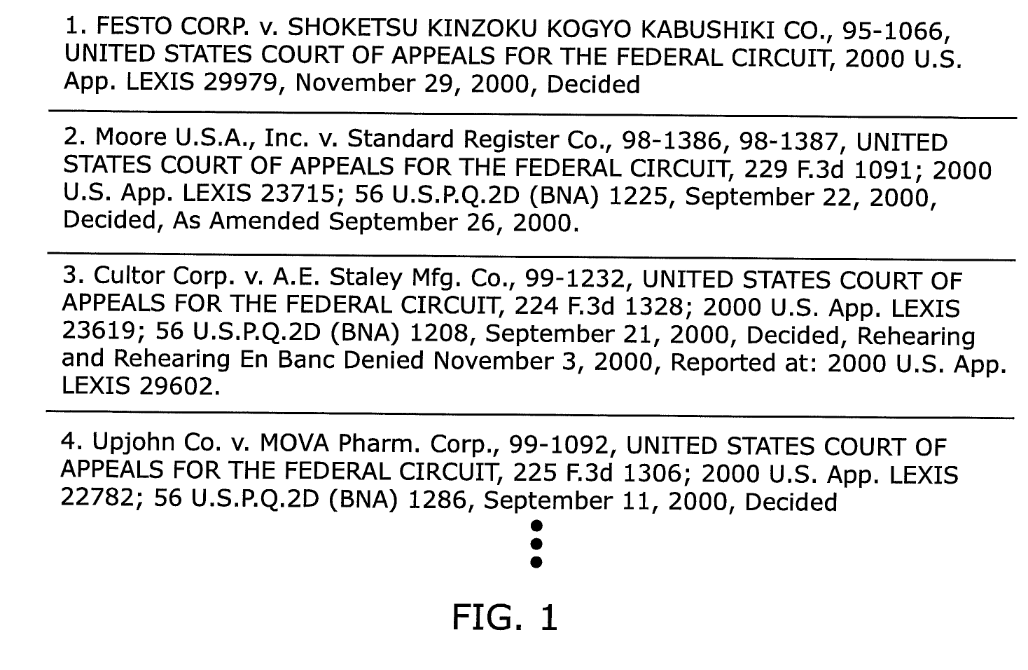

For example, a legal keyword search of federal cases might return a collection of some 50-100 cases, which are typically displayed as a textual list of case titles as shown in FIG. 1. A user must either add new keywords to reduce the size of the search result set (potentially eliminating relevant cases), or manually examine each and every case to determine whether it actually bears on the topic of interest. However, it will often be the case that a few seminal cases will be cited by the vast majority of cases touching on a topic. (For example, in recent years, it would be a rare legal opinion having a significant treatment of the doctrine of equivalents in patent law that did not cite Warner-Jenkinson Co. v. Hilton Davis Chem. Co., 520 U.S. 17, 41 U.S.P.Q.2d 1865 (1997)). By examining all cases cited in each of the documents of the search set (in the parlance of the invention, the objects linked to by the cases in the set), those cases frequently cited by cases having some mention of the keywords can be identified. Such cases are likely to represent a relatively small group of cases that are likely to be highly relevant to the searcher.

In certain preferred embodiments of the invention, this method can be refined by looking only at citations in proximity to the keywords (e.g., in the same paragraph). In the particular case of legal searching, signals such as See, See also, Cf, But cf, and But see may also help to identify whether or not the cited case is in accord with the citing case. These signals may not be perfect predictors of the outcome of any given case, but in the aggregate they can provide a good deal of information to the searcher.

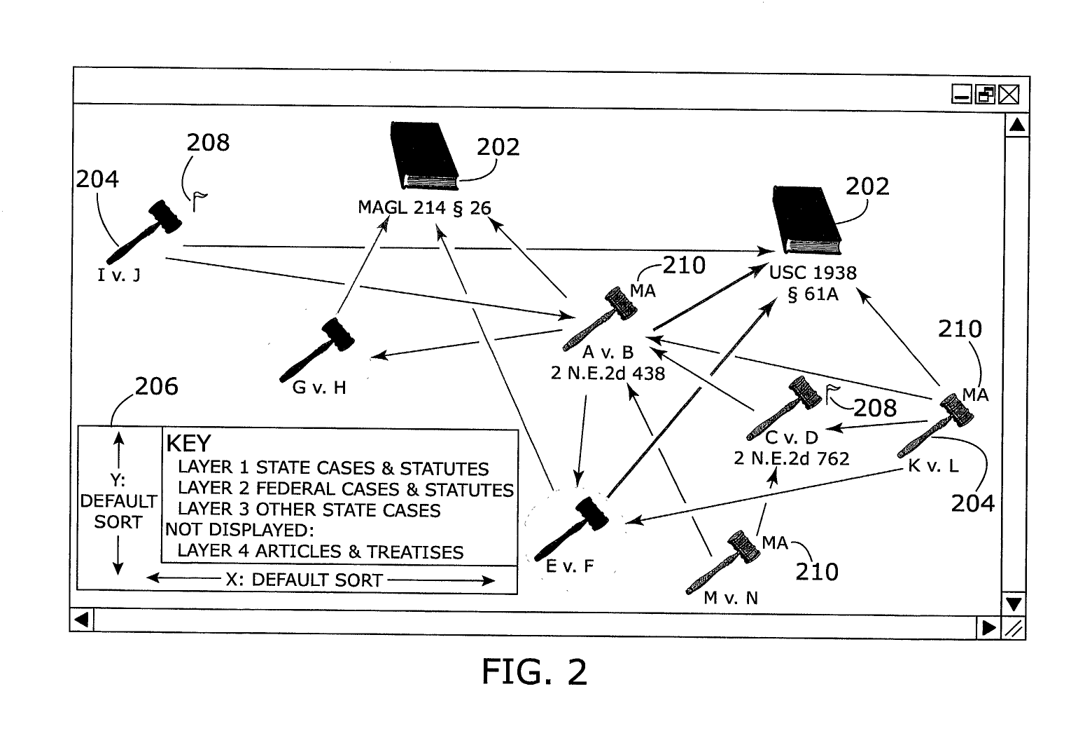

A search result display according to the invention shows both search objects and links, as shown in FIG. 2. Icons are used to make different object types more recognizable (the icons shown may be defaults, or may be specified using the group display wizard as detailed below). For the legal search shown, statutes are represented by book icons 202, and decisions are represented by gavels 204, which are colored either brown or black to represent state or federal cases, respectively. Key 206 specifies which layers are currently being displayed and how the objects are sorted (if at all). These options may be set using the layer properties dialog described below. Objects which link to undisplayed layers are marked with flags 208, while some cases carry special notations 210. (Flags could also be used, for example, to denote cases that have user annotations). Links from cases are colored to show different types of treatment; red links represent negative treatment, blue links represent positive treatment, and green links represent statutory interpretation. In the embodiment described below, link colors are set via the layer properties dialog; in other embodiments, link colors may be set using the group display wizard. Two of the cases 204 are highlighted in yellow to identify their group status (as defined in the group display wizard described below).

The practice of grouping certain objects or categories of objects in layers for editing and display purposes is known in the arts of computer graphics and computer-aided design, but has not previously been applied to result displays for searches. The present invention encompasses the realization that the layering concept can give the user unprecedented control over the display of search results, allowing rapid understanding of the scope and interrelatedness of searched material.

In some embodiments of the invention, the user may annotate individual objects or links, for example by right-clicking an object and selecting “annotate” from a context-sensitive menu to access a dialog box. These annotations may be displayed, for example as “tips” that are displayed when a cursor is moved over the object. Objects may be colored or have other display attributes indicating that they have been annotated. In certain preferred embodiments of the invention, annotations may be saved by the user and displayed in subsequent searches that return the same objects or links.

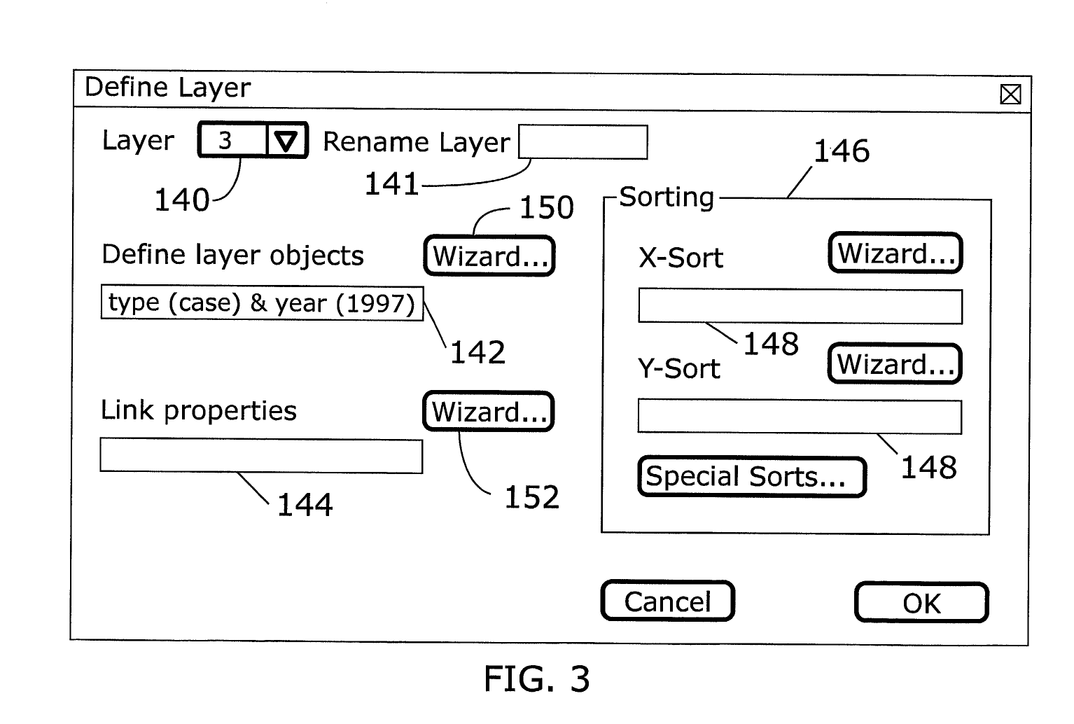

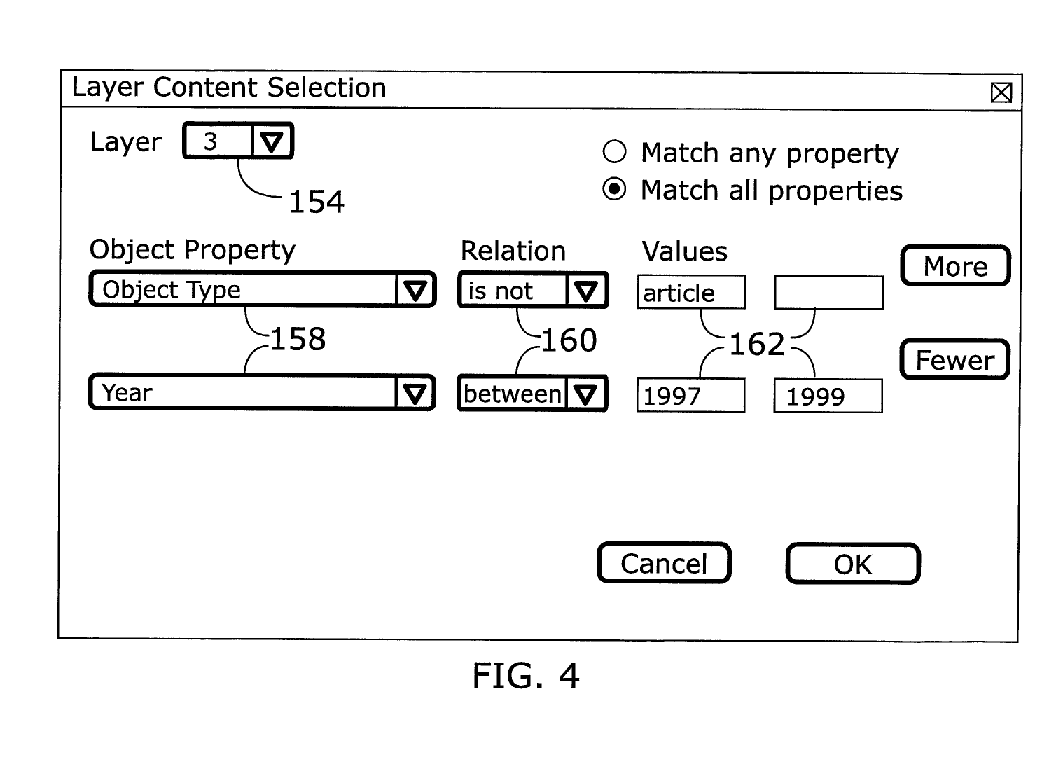

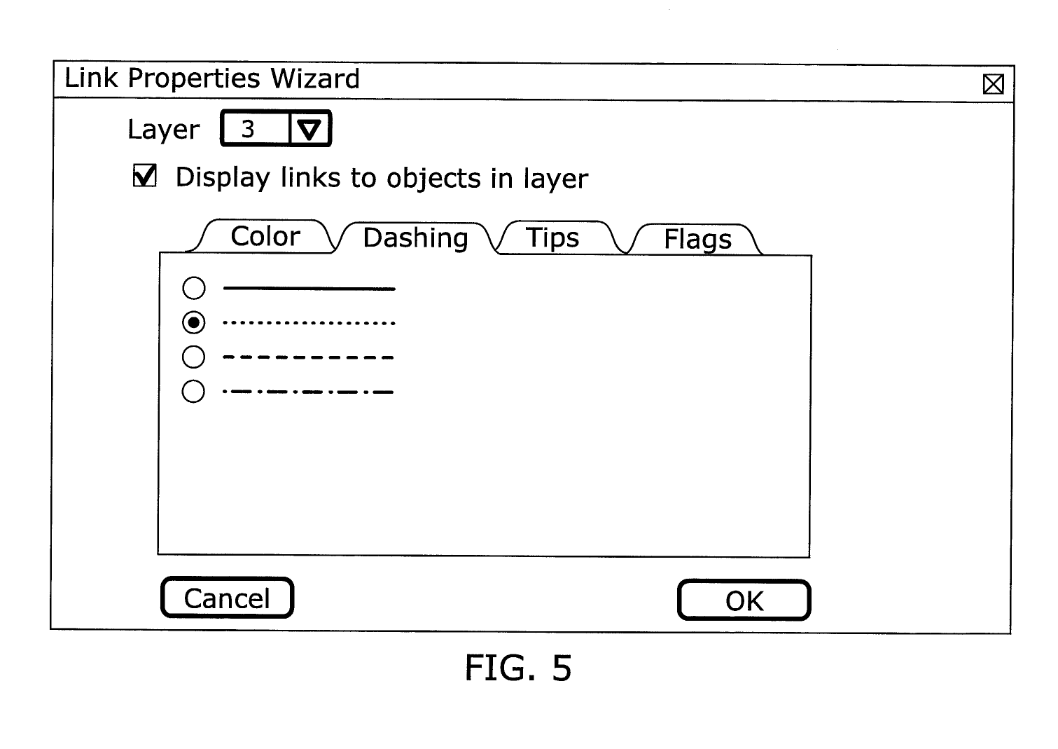

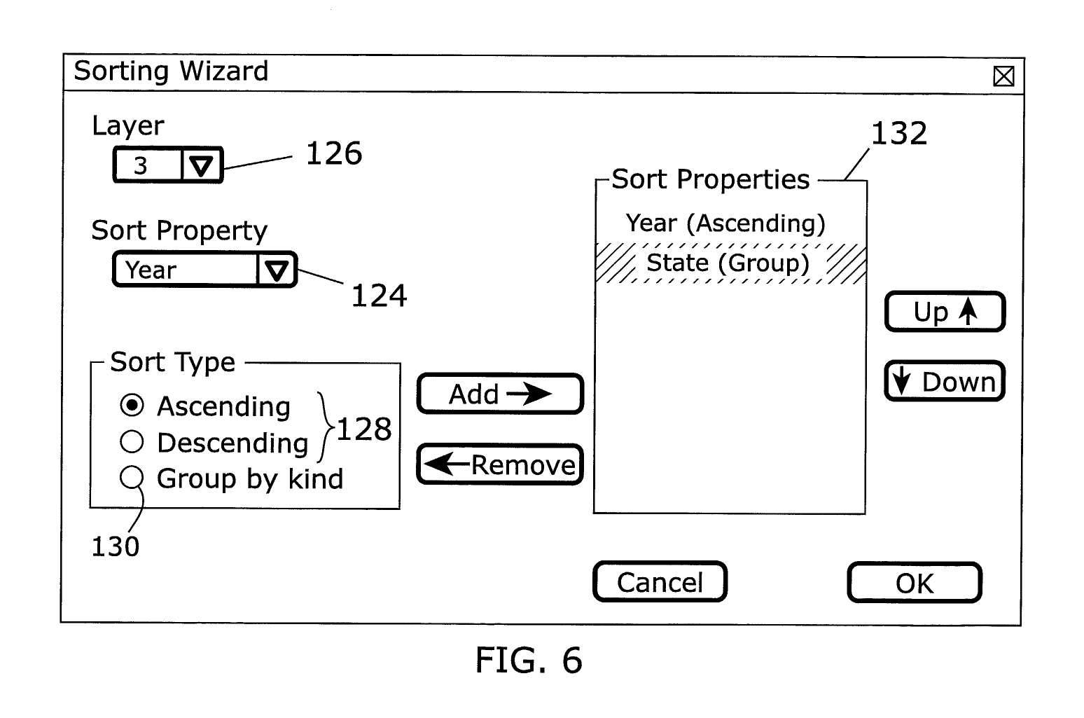

According to the invention, the user may define layers and specify options for each layer, as shown in the layer properties dialog in FIG. 3. For the specified layer 140, this dialog allows the user to specify a rule 142 to determine which objects will appear in the layer. (The layer may also be renamed by typing in dialog box 141). This dialog also allows the user to specify 144 the properties of links to objects in the layer. Object and link properties may be specified by means of wizards 150, 152, as shown in FIGS. 4 and 5, or may be defined using text boxes 142, 144. In certain embodiments of the invention, the layer definitions and link properties selected in the wizards are converted to text codes, which appear in text boxes 142, 144. The positions of objects may be specified using the sorting box 146. As with other properties, these may be specified directly in text boxes 148 or via a sorting wizard, shown in FIG. 6.

FIG. 4 shows the layer object definition wizard. As shown, the user is specifying which objects will appear in layer 3, selected in pull-down menu 154. The user selects one or more object properties that define the group using property menus 158. For each property, a relation 160 and one or more values 162 are selected. The layer definition may represent either the union or the intersection of the conditions so specified. Layers may also be determined, for example, by search level when a search explores links to objects outside the target group of the underlying search.

FIG. 5 shows the link display wizard. For each layer, the user selects whether links to objects in that layer are displayed using checkbox 164. If links are to be displayed, the user may use tab box 166 to set color, dashing, etc. In some embodiments, these settings may be overridden by group display options, further described below.

FIG. 6 depicts the sorting wizard. For the specified layer 126, objects may be sorted on either or both of the X- and Y-axes according to selected properties, which may be determined by menu 124. For properties that may be ordered, the user may select an ascending or descending sort 128. For any property, the user may instead select to group like objects by selecting the group button 130. Certain properties may have special sorts available (e.g., map display). If the user wishes to sort on multiple properties for a specific axis, list box 132 may be used to specify the order of the properties for the sort. When no specific sort characteristics are selected, the display may use either a default sort on each axis, or may use a two-dimensional heuristic, such as placing objects so as to minimize displayed link crossings.

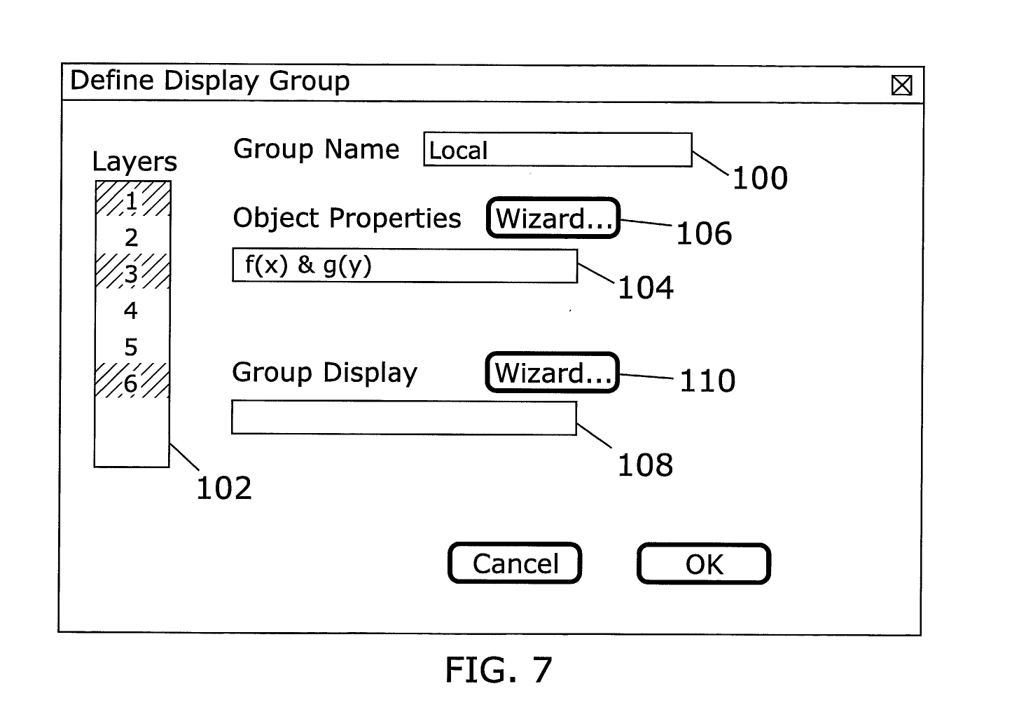

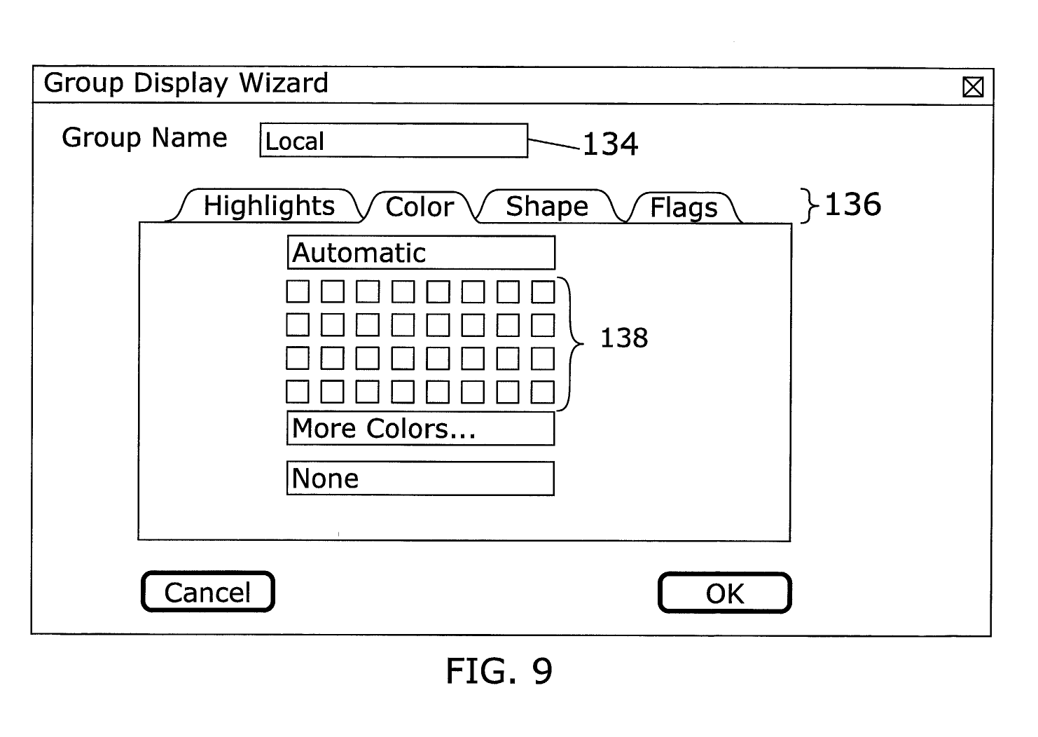

FIG. 7 shows a more detailed depiction according to one embodiment of the invention of the process of defining how objects are displayed in one or more particular layers, by defining object groups. A group is created by selecting a group name using control 100. Layer selection dialog 102 allows the user to specify in which layer(s) the group will appear. (As shown, the layers are identified by number, but layer names could also be used). The objects that appear in the group are specified using the “Object Properties” dialog 104, either by directly typing a group definition or by using a group definition “wizard” (as shown in FIG. 4), which may be accessed by button 106. Highlighting or otherwise marking the objects within the group is accomplished either by direct typing of command language into text box 108 or by accessing a group display wizard (FIG. 9) via button 110.

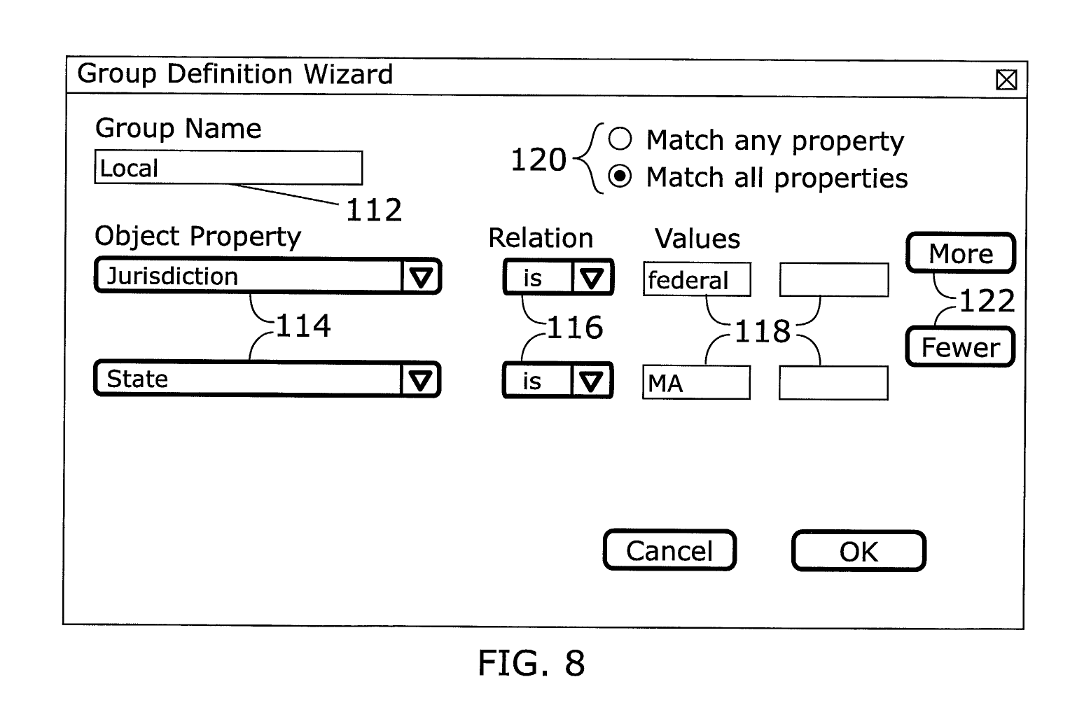

FIG. 8 depicts the group definition wizard dialog. For the displayed group name 112, the user may select one or more object properties that will define the group, using property menus 114. For each property, a relation 116 is selected (e.g., is, is not, contains, does not contain, is equal to, is greater than, is less than, is between), and one or more values 118 are specified. The user may toggle between conjunctive and disjunctive relations between the properties using control 120. The number of properties specified may be increased or decreased using buttons 122. By selecting these items, the user specifies which objects (within the original search set) will be members of the group. In the embodiment shown, when the user has finished selecting the properties that define the group, his selections are translated into a textual definition that is entered in box 104.

FIG. 9 depicts the group display wizard. For the displayed group name 134, the user may specify highlighting, color, shape, and/or flags for the group by selecting a tab 136. As shown, the color tab has been selected, and the user is presented with a choice of color boxes 138, as well as options for automatically selecting a color, choosing a custom color, or using no colors to mark the group. It will be apparent that other methods of identifying group members may also be specified by the use of additional or substitute tabs 136. FIG. 2 shows two cases belonging to a particular group that have been highlighted in yellow using the group display wizard.

The various dialog boxes and wizards of the described embodiments of the invention provide a very large degree of user control of display properties. Because so many options are available for displaying properties, it may become useful to provide certain predefined “default” choices for users to select. For example, default coloring and icon selections may be provided for specifying cases, statutes, journal articles, etc. Similarly, default options may be used for link coloring and even automatic layer generation. Novice users may simply select useful default options from a predefined list, while “power” users may use the default options as starting points for custom displays (or even construct displays from scratch using the dialogs and wizards), which may be saved for use in later searches.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of searching a collection of linked objects and displaying the results, comprising:
acquiring a search group of heterogeneously typed objects, wherein at least one of the objects comprises a link to another object;
determining for at least a portion of the objects in the search group a set of targets of links from the objects, including determining whether the link targets are inside the search group; and
displaying a representation of at least one searched object, the representation having at least one display attribute determined by the set of link targets.

2. A method of searching a collection of linked objects and displaying the results, comprising:
acquiring a search group of objects, wherein at least one of the objects comprises a link to another object;
determining for at least a portion of the objects in the search group a set of targets of links from the objects, including determining whether the link targets are inside the search group; and
displaying a representation of at least one searched object, the representation having at least one display attribute determined by the set of link targets,
wherein displayed representations are arranged into a plurality of display layers, and wherein the display layers can be independently hidden or displayed.

3. The method of claim 1 or 2, wherein the display attribute is selected from the group consisting of color, shape, size, position, highlighting, graphical flags, and labeling text.

4. The method of claim 1 or 2, wherein representations of a plurality of objects are displayed on a graph.

5. The method of claim 1 or 2, wherein representations of a plurality of objects are displayed, and wherein at least one link between objects is depicted by a connector between the representations.

6. The method of claim 5, wherein a display attribute of the connector is determined by a property selected from the group consisting of the type of the linking object, the type of the link target, and the type of the link.

7. The method of claim 1 or 2, wherein a display attribute of the representation is determined by object metadata.

8. The method of claim 1 or 2, wherein determining link targets includes recursively determining targets of links of an expanded set of objects comprising the original search group and the objects linked to by the search group.

9. The method of claim 8, wherein the recursion level is in the range of 1-10.

10. The method of claim 1 or 2, wherein the search objects comprise documents selected from the group consisting of legal opinions, legal treatises, statutes, briefs, and law review articles.

11. The method of claim 1 or 2, wherein the search objects comprise scientific or medical writings, and wherein the links comprise citations to other scientific or medical writings.

12. The method of claim 1 or 2, wherein the search objects comprise patents and patent applications and the links comprise references to related patents and patent applications.

13. The method of claim 1 or 2, further comprising annotating at least one of the search objects.

14. The method of claim 1 or 2, wherein at least a portion of the searched objects and link targets are classified into a plurality of groups, further comprising setting a display attribute for all members of a group.

15. The method of claim 1 or 2, wherein displayed representations are sorted on at least one axis according to a property of the objects represented.

16. A method of searching a collection of objects and displaying the results, comprising:
acquiring a first search group of objects;
displaying a representation of at least a portion of the first search group of objects; and
annotating one or more members of the first search group of objects, wherein annotations may be selectively displayed with the representation of the annotated objects.

17. The method of claim 16, further comprising:
acquiring a second search group of objects; and
displaying a representation of at least a portion of the second search group of objects, wherein displaying the representation of annotated objects that are members of both the first search group and the second search group includes selectively displaying annotations of the objects.

18. The method of claim 16, wherein the representations are displayed on a graph.

19. The method of claim 16, wherein the objects include links to other objects, and wherein at least a portion of the links are displayed as connectors between representations of the objects.

20. The method of claim 19, further comprising annotating one or more links.
